(19) United States
(12) Patent Application Publication
(10) Pub. No.: US 2008/0301184 A1
(43) Pub. Date: Dec. 4, 2008

(54) System and Method for Updating Mailing Lists

(75) Inventors: John W. Sussmeier, Cold Spring, NY (US); Denis J. Stemmle, Stratford, CT (US); John P. Miller, Shelton, CT (US); David K. Lee, Monroe, CT (US)

Correspondence Address: PITNEY BOWES INC.;35 WATERVIEW DRIVE, P.O. BOX 3000, MSC 26-22, SHELTON, CT, 06484-8000, US

(73) Assignee: PITNEY BOWES INC., Stamford, CT (US)

(21) Appl. No.: 11/755,633

(22) Filed: May 30, 2007

(51) Int. Cl. G06F 19/00; G06F 17/40

(52) U.S. Cl. 707/104.1

(57) ABSTRACT

According to some embodiments, a system and method are provided to receive an indication from a postal recipient that an unsolicited mail piece is not desired, the indication comprising a digital image of at least a portion of the unsolicited mail piece, store data associated with the postal recipient based on one or more identifiers, and provide the data associated with the postal recipient to one or more mailers to indicate that the postal recipient requests to opt-out from future mailings.

### BACKGROUND

It is common place when opening a mailbox to find several unsolicited mail pieces such as catalogs and advertisements. Unsolicited mail pieces may comprise advertisements, catalogs, and samples for items such as tools, clothing, food, household supplies, investments, etc. In many instances, the receipt of these unsolicited mail pieces is undesired. For example, receipt of diaper advertisements or sample diapers by a household that does not have children may be undesired to the recipient.

Often, direct mailers may continue to send the same type of mail pieces to a recipient even though the recipient has no interest in the content and will likely never respond to the numerous unsolicited mail pieces. Morevover, since catalogs and samples are expensive to create and distribute, over sending of unsolicited mail pieces may be wasteful and expensive to the direct mailer. Today, it is difficult to convey to the direct mailer that a mail recipient has no intention to respond to a particular direct mail category other than a recipient's lack of response over time.

### SUMMARY

In some embodiments, a method is diclosed. The method is directed to receiving an indication from a postal recipient that an unsolicited mail piece is not desired. The indication may comprise a digital image of at least a portion of the unsolicited mail piece. The method is further directed to storing data associated with the postal recipient based on one or more identifiers, and providing the data associated with the postal recipient to one or more direct mailers to indicate that the postal recipient requests to opt-out from future mailings.

In some embodiments a system is disclosed. The system may comprise a cell phone, a database, and a computer system. The cell phone may comprise a camera to capture a digital image of an unsolicited mail piece from a direct mailer. The unsolicited mail piece may comprise one or more identifiers. The computer system may receive an indication via the cell phone from a postal recipient that an unsolicited mail piece is not desired. The indication may comprise a digital image of at least a portion of the unsolicited mail piece. The computer system may store data in the database where the data is associated with the postal recipient based on one or more identifiers. The computer system may also provide the data associated with the postal recipient to one or more direct mailers to indicate that the postal recipient requests to opt-out from future mailings.

In one embodiment a method is disclosed. The method is directed to receiving an indication from a postal recipient that an unsolicited mail piece is not desired where the indication comprises the unsolicited mail piece. The method also describes storing data associated with the postal recipient based on one or more identifiers, and providing the data associated with the postal recipient to one or more direct mailers to indicate that the postal recipient requests to opt-out from future mailings.

In one embodiment a method is directed towards receiving an unsolicited mail piece from a direct mailer, the unsolicited mail piece comprising one or more identifiers. The method describes capturing a digital image of the one or more identifiers, and sending the digital image to a third party service provider.

Therefore, it should now be apparent that the invention substantially achieves all the above aspects and advantages. Additional aspects and advantages of the invention will be set forth in the description that follows, and in part will be obvious from the description, or may be learned by practice of the invention. Various features and embodiments are further described in the following figures, descriptions, and claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 illustrates a method for processing data according to some embodiments.

FIG. 2 illustrates a method for processing data according to some embodiments.

FIG. 3 illustrates a system for processing data according to some embodiments.

FIG. 4 illustrates a method for processing data according to some embodiments.

FIG. 5 illustrates a method for processing data according to some embodiments.

### DETAILED DESCRIPTION

The several embodiments described herein are provided solely for the purpose of illustration. Embodiments may include any currently or hereafter-known versions of the elements described herein. Therefore, persons in the art will recognize from this description that other embodiments may be practiced with various modifications and alterations.

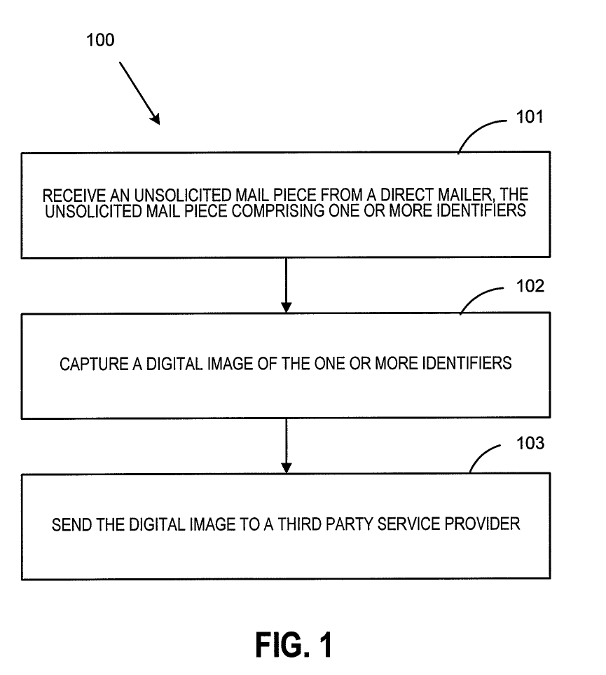

Now referring to FIG. 1, an embodiment of a method 100 is illustrated. At 101, an unsolicited mail piece is received from a direct mailer, the unsolicited mail piece comprising one or more identifiers. For example, a recipient may receive unsolicited mail (e.g. junk mail) at a location such as, but not limited to, a post office box, or a mailbox. The unsolicited mail piece may be sent from a direct mailer, such as, but not limited to, a catalog provider or an advertising company. A mailer such as a direct mailer may send printed matter directly to prospective customers however, in some embodiments a direct mailer may be a third party mailer. A third party mailer may send mail to prospective customers of a company or corporation other than the third party mailer. Each of the one or more identifiers may comprise unique symbols, numbers, and/or bar codes to identify a recipient, category of mail, a direct mailer, and/or a type of mail piece. The one or more identifiers may be placed on an envelope by a mailer or by a third party. Placing the one or more identifiers on an envelope may indicate that the mailer desires to know which mail recipients want to opt out from future mailings.

For illustrative purposes, and to aid in understanding features of the invention, an example will now be introduced. This example will be carried through the detailed description and this example is not intended to limit the scope of the invention.

A homeowner opens up his mailbox to find a first catalog from a clothing company, a second catalog from a tool company, and a free sample of diapers. While the homeowner has previously ordered from the clothing company, he has never ordered, nor ever intends to order from the tool company. Since the homeowner, in this example, has no children, he does not desire the free diaper sample.

Next, at 102, a digital image of the one or more identifiers is captured. In one embodiment, a digital image of the one or more identifiers may be captured via a cell phone comprising a camera. In one embodiment, a web camera (“web cam”) or a digital camera may capture the digital image. In some embodiments, the digital image may be captured by scanning a face of the mail piece. The one or more identifiers may be located anywhere on the unsolicited mail piece. For example, the one or more identifiers may be located on an outside portion of an envelope, in an address area portion of a catalog, or on the content contained within an envelope. Continuing with the above example, the homeowner may determine that he does not want to receive future mailings of the tool catalog. So, to opt-out of receiving the tool catalog, the homeowner may take a digital image of the tool catalog where the digital image comprises the one or more identifiers.

The digital image may be sent to a third party service provider, as illustrated at 103. Sending may comprise emailing the digital image to a specific email address, or sending the digital image to a specific phone number. In one embodiment, the digital image may be sent to the third party service provider via an Internet connection. In some embodiments, the digital imaged may be faxed. For example, and referring to the above example, the homeowner may send the digital image to a third party service provider by sending the digital image to a phone number such as 1-800-STP-MAIL. The homeowner may send the digital image to the phone number by using the same camera cell phone used to capture the image.

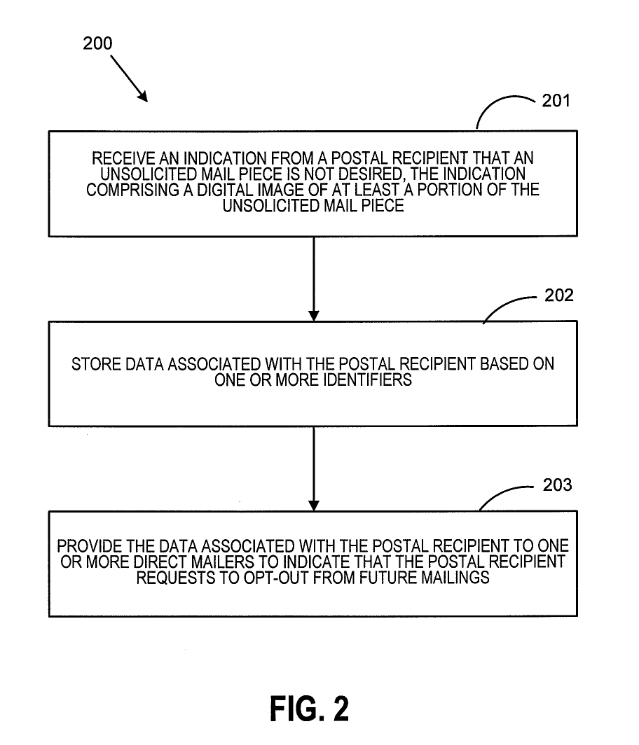

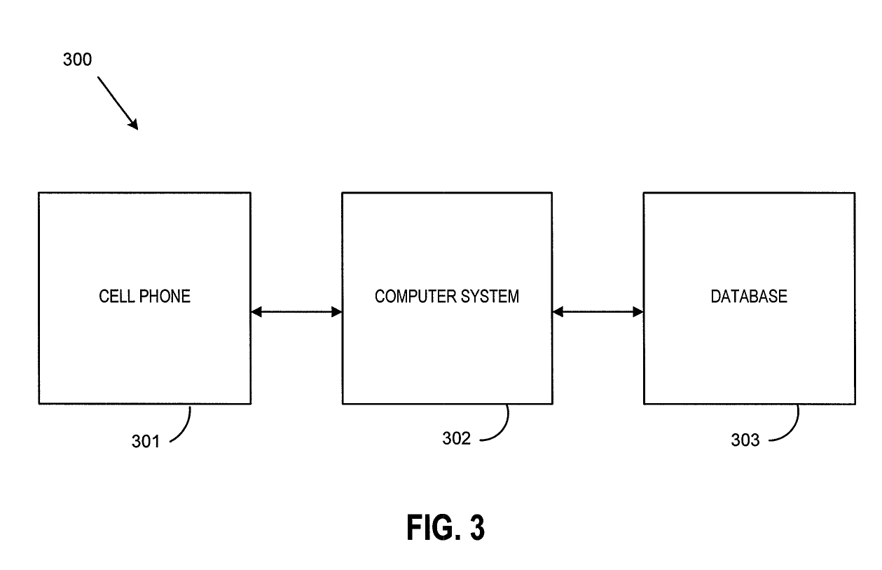

Now referring to FIG. 2, and embodiment of a method 200 is illustrated. The method 200 may be executed by any combination of hardware, software, and firmware, including but not limited to, the system 300 of FIG. 3. At 201, an indication is received from a postal recipient that an unsolicited mail piece is not desired, the indication comprising a digital image of at least a portion of the unsolicited mail piece. In some embodiments, the indication is received at a third party service provider however, in some embodiments, the indication is received at the direct mailer.

For example, and continuing with the above example, the digital image sent by the homeowner may be received by a third party service provider. In some embodiments, once the digital image is received by the third party service provider, the digital image may be decoded by processing or scanning the image so that the one or more identifiers may be read and converted into data.

Next at 202, data associated with the postal recipient is stored. The data may be based on one or more identifiers such as a recipient identifier, a direct mailer identifier, a category identifier and/or a type of mail piece identifier. In some embodiments, the identifiers may include a POSTNET barcode and/or a PLANET code.

The recipient identifier may indicate a recipient of the unsolicited mail piece comprising a name, address, and/or a zip code of the recipient. In some embodiments, the recipient identifier may be coded, such as, but not limited to, a bar code. The direct mailer identifier may comprise a name, customer number, or any unique identifier that may be associated with the direct mailer. The mail piece identifier may comprise a specific catalog number. For example, if a company has a tool catalog and a clothing catalog, a recipient may notify the third party service provider that a specific catalog is no longer desired. The category identifier may specify a category of unsolicited mail that is undesired. For example, a first category identifier may specify that a first unsolicited piece of mail is associated with a tool category and a second category identifier may specify that a second unsolicited piece of mail is associated with a clothing category. A recipient who indicates that a specific category is undesired may opt out from all unsolicited mail pieces associated with direct mailers that send unsolicited mail pieces having a category identifier associated with the specific category. In some embodiments, a postal recipient profile is created based on the one or more identifiers.

Referring to the homeowner example from above, data associated with the homeowner may be stored in a database, the data based on the digital image comprising the one or more identifiers that the homeowner sent to the third party service provider. If the homeowner sends a digital image comprising one or more identifiers associated with the sample of diapers, a computer system, in response, may store data comprising the homeowner's name and address, a category identifier of children's products and data associated with the direct mailer who sent the diapers.

At 203, the data associated with the postal recipient is provided to one or more direct mailers to indicate that the postal recipient requests to opt-out from future mailings. In some embodiments, a third party service provider may compile a list of recipients who desire to opt-out of future mailings and may provide the compiled list to one or more direct mailers. For example, the homeowner's data may be sent to every direct mailer that manufactures children's products. Sending compiled lists of recipients to direct mailers may allow direct mailers to save on expenses by not sending mailings to recipients who will never use their products and/or services.

Now referring to FIG. 3, an embodiment of a system 300 is illustrated. The system may comprise a cell phone 201, a computer system 202, and a database 203. The cell phone 201 may comprise a camera to capture a digital image of an envelope code.

The computer system 202 may comprise a processor, memory, and a medium to store instructions. The memory may comprise, according to some embodiments, any type of memory for storing data, such as a Single Data Rate Random Access Memory (SDR-RAM), a Double Data Rate Random Access Memory (DDR-RAM), or a Programmable Read Only Memory (PROM). The processor may be any processor that is, or becomes known.

The computer system 202 may receive an indication from a postal recipient via the cell phone 201 that an unsolicited mail piece is not desired. The indication may comprise a digital image of at least a portion of the unsolicited mail piece. The computer system 202 may detect one or more identifiers in the digital image by analyzing the digital image. The computer system 202 may store data in the database 203, the data being associated with the postal recipient based on one or more identifiers. The computer system 202 may provide the data associated with the postal recipient to one or more direct mailers to indicate that the postal recipient requests to opt-out from future mailings from the direct mailer.

In one embodiment, if a mailer sends two identical mail pieces to the same recipient, it may be beneficial to both the mailer and the recipient to correct this situation. A mailing list may comprise a same recipient that is listed two or more times, each time with slightly different information. For example, one listing may include the title “Jr.”, and a second listing may be identical in all aspects, except without comprising the title “Jr.” The mailer may not know if these are two people, or the same person but it may be important to distinguish whether the recipient desires to continue receiving one of the mail pieces in future mailings, or if the recipient does not want to receive any mail pieces from the mailer in the future. In a first situation, the recipient may capture and transmit a digital image of all but one of the mail pieces to a third party service provider and by not transmitting information on the one mail piece, the recipient indicates a desire to continue receiving the mail piece in the future. If the recipient desires to stop receiving all copies of the mail piece in the future, the recipient may capture and transmit a digital images each copy of the mail piece. The computer system 202 may receive, one, two or more separate indications from a postal recipient, each indication associated with, one, two or more mail pieces comprising a same mail piece identifier. The computer system may provide the data associated with the postal recipient to one or more mailers to indicate that the postal recipient requests to receive only a single mailing of the mail piece associated with the mailer identifier, or no future mailings of the mail pieces associated with the identifier depending on the number of digital images received.

In one embodiment, instructions, stored on a medium, when executed by a processor may perform a method, the method comprising receiving an indication from a postal recipient that an unsolicited mail piece is not desired, storing data associated with the postal recipient based on one or more identifiers, and providing the data associated with the postal recipient to one or more direct mailers to indicate that the postal recipient requests to opt-out from future mailings. In one embodiment, the indication comprises a digital image of at least a portion of the unsolicited mail piece

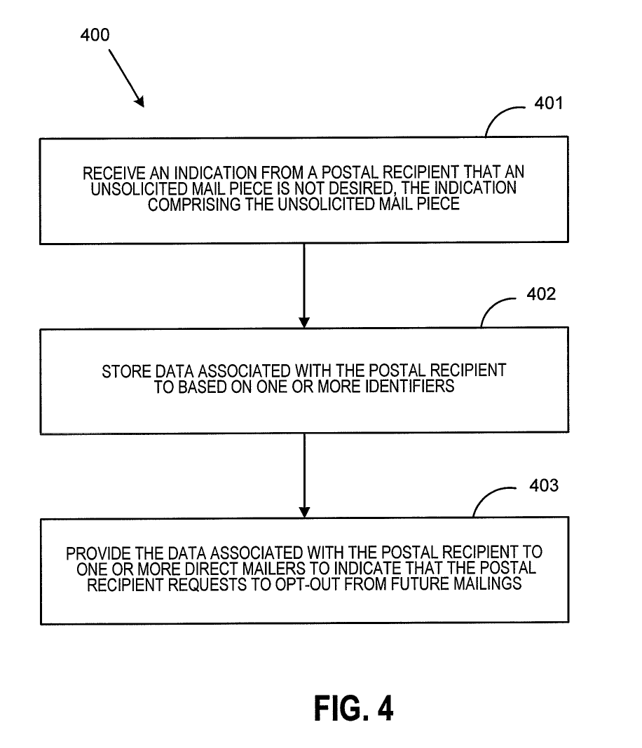

Now referring to FIG. 4, an embodiment of a method 400 is illustrated. The method 100 may be executed by any combination of hardware, software, and firmware, including but not limited to, the system 300 of FIG. 3. At 401, an indication from a postal recipient that an unsolicited mail piece is not desired is received, the indication comprising the unsolicited mail piece. In some embodiments, the unsolicited mail piece is received in a third party service provider envelope.

For example, a homeowner may open up his mailbox to find a first catalog from a clothing company, a second catalog from a tool company, and a free sample of diapers. The homeowner may not desire the tool catalog and the free sample of diapers. To indicate that he no longer wishes to receive future mailings, the homeowner may place one or more of the unsolicited mail pieces in an envelope provided by a third party service provider. The envelope may be mailed to the third party provider. In one embodiment, the envelope is a pre-paid postage envelope and in some embodiments, the envelope may be a postage paid envelope.

Next at 402, data associated with the postal recipient is stored, the data being based on one or more identifiers. In some embodiments, each mail piece may comprise one or more identifiers and, each identifier may be located on an outside portion of a respective unsolicited mail piece. In some embodiments, each identifier may be scanned by, for example, an optical scanner. Scanning each identifier may allow the data associated with a postal recipient to be input into a database or computer system.

For example, and continuing with the homeowner example, after the envelope is received from the homeowner, the third party service provider may open the envelope comprising the unsolicited mail pieces. The third party may scan each mail piece and its respective one or more identifiers so that the data associated with the homeowner has been entered into a database.

Next, at 403, the data associated with the postal recipient is provided to one or more direct mailers to indicate that the postal recipient requests to opt-out from future mailings.

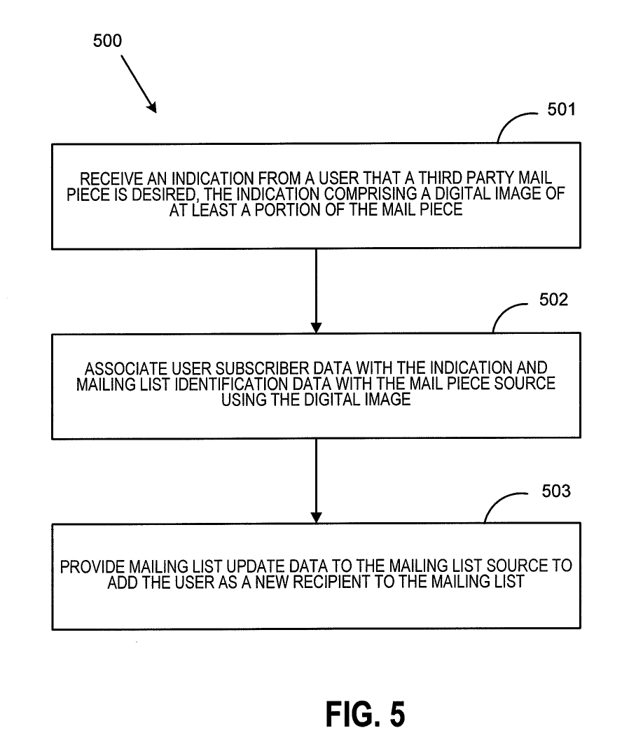

Now referring to FIG. 5, an embodiment of a method for subscribing to a mailing list 500 is illustrated. The method 500 may be executed by any combination of hardware, software, and firmware, including but not limited to, the system 300 of FIG. 3. At 501, an indication from a user that a catalog or mail piece is desired is received. The indication comprises receiving a digital image of a portion of the mail piece that was addressed to a third party. The system receives an indication from a user that a third party mail piece is desired, the indication comprising a digital image of at least a portion of the mail piece. In step 502, the system associates user subscriber data with the indication and mailing list identification data with the mail piece source using the digital image. The mail piece source may be identified using a code or address information. In step 503, the system provides mailing list update data to the appropriate mailing list source/sources to add the user as a new recipient to the mailing list. The mailing list update data may be provided individually or in a batch.

In an alternative embodiment applicable to any of the embodiments herein, the method and system for updating mailing lists uses a direct to mailer configuration in effect bypassing the third party service provider. Accordingly, the user would send the digital image of the undesired mail piece directly to the mailer or the mailer's contractor using a dedicated telephone number. The user may obtain that dedicated telephone number from the mail piece. For example, the opt-out image receiving telephone number may be printed on the address label or cover of the catalog or other mail piece.

In another alternative embodiment applicable to any of the embodiments, the user of the system may be identified using the telephone number of the cellular telephone and a user identification database such as a caller ID database. The cellular telephone utilized may include the MOTOROLA RAZR camera phone and the communications link to the opt-out service provider may include the cellular and POTS telephone networks or suitable alternatives. The opt-out service provider may use servers such as DELL ITANIUM servers running software implementing the system with additional SQL database software and telephone system modem bank interface support or suitable alternatives such as geographically load balanced servers from SUN MICROSYSTEMS. The opt-out service provider communicates with client mailing list vendors and mailers using communications channels that may include the Internet and secured channels such as a VPN tunnel over the Internet or other suitable communications systems. The software implementing the system on the server includes JAVA and/or C++ code for processing the images received to extract data through OCR or other means along with extracting associated data from the database and then processing the mailing list update messages. The mailing list update messages may be individually sent or may be batched by mailing list vendor and may be sent using the VPN channels.

In yet another alternative embodiment applicable to any of the embodiments described herein, the user may receive two copies of the same catalog or other mailing due to an error in the mailing list such as duplication caused by slight variations in name or address. In such a system, the user may request that the mailing list be updated to delete the duplicate entry “dedupe”. For example, the user may send a digital image of one of the duplicate catalogs or mail pieces to indicate a desire to dedupe the mailing list. In another alternative, the user may send an image taken from each of the duplicate catalogs and an indication requesting that the mailing list duplication be removed. Additionally, the opt-out service provider may provide an additional telephone number to be used with dedupe requests.

In yet another alternative embodiment, a method for updating a mailing list by adding a new recipient is described using the systems described herein. A method for a user to request addition to a mailing list includes obtaining a mail piece from a third party such as a friend who received a desired catalog. Here, the mail piece was sent to the third party by a mailer such as the catalog vendor or catalog contractor. The user who is not on the mailing list then uses an imaging device such as a digital cellular telephone camera to capture a digital image of at least a portion of the mail piece. The user is using an imaging device associated with an assigned communication number such as a cellular telephone number and that information can be used to subscribe to the catalog mailing list.

The user then sends the digital image to a mailing list service provider (or alternatively directly to the catalog company). The mailing list service provider then obtains user data in order to process the subscribe request. One method for obtaining the user data required is to use the communications number or cellular telephone number to obtain associated user data such as by using a caller ID for name and address lookup information.

Mailing list identification data associated with the captured digital image is obtained such as by recognizing alpha-numeric text using an OCR process or by reading a code with encoded information such as a 2D barcode. The appropriate mailing list is updated using the user data and the mailing list identification data to add a new recipient. The user may also maintain an account with the mailing list update service so that his telephone number is associated with his subscriber/user data.

A number of embodiments of the present invention have been described. Nevertheless, it will be understood that various modifications may be made without departing from the spirit and scope of the invention. Other variations relating to implementation of the functions described herein can also be implemented. Accordingly, other embodiments are within the scope of the following claims.

What is claimed is:

1. A method for providing mailing data comprising:
receiving an indication from a postal recipient that a received mail piece is not desired, the indication comprising a digital image of at least a portion of the mail piece;
obtaining data associated with the postal recipient based on one or more identifiers; and
providing the data associated with the postal recipient to one or more mailers to indicate that the postal recipient requests to opt-out from future mailings.

2. The method of claim 1, wherein the mail piece is unsolicited and the digital image comprises the one or more identifiers.

3. The method of claim 1, further comprising:
decoding the digital image; and
creating a postal recipient profile based on the one or more identifiers.

4. The method of claim 1, wherein the one or more identifiers comprises a mailer identifier, a recipient identifier, and a piece identifier.

5. The method of claim 1, wherein the indication is received at a third party service provider.

6. A method for a user to request addition to a mailing list comprising:
obtaining a mail piece from a third party, wherein the mail piece was sent to the third party by a mailer;
capturing a digital image of at least a portion of the mail piece using an imaging device associated with an assigned communication number;
sending the digital image to a mailing list service provider, wherein the mailing list service provider obtains user data associated with the communications number and mailing list identification data associated with the captured digital image and wherein a mailing list is updated using the user data and the mailing list identification data.

7. The method of claim 6, wherein the communication number is a telephone number of a cellular telephone and the imaging device comprises a digital camera incorporated in the cellular telephone.

8. A method comprising:
receiving an unsolicited mail piece from a mailer, the unsolicited mail piece comprising one or more identifiers;
capturing a digital image of the one or more identifiers; and
sending the digital image to a third party service provider.

9. The method of claim 8, wherein the digital image is captured via a cell phone camera and is sent to the third party service provider via the cell phone.

10. The method of claim 8, wherein the digital image is captured via a web camera and is sent to the third party service provider via an internet connection.

11. The method of claim 8, wherein the one or more identifiers comprises a mailer code and a subject code.

12. A system comprising:
a cell phone comprising a camera to capture a digital image of an envelope code;
a database; and
a computer system to:
store data in the database, the data associated with the postal recipient based on one or more identifiers;
receive an indication via the cell phone from a postal recipient that an unsolicited mail piece is not desired, the indication comprising a digital image of at least a portion of the unsolicited mail piece; and
provide the data associated with the postal recipient to one or more mailers to indicate that the postal recipient requests to opt-out from future mailings.

13. The system of claim 12, wherein the digital image comprises the one or more identifiers.

14. The system of claim 12, where the computer system is to decode the digital image.

15. The system of claim 12, wherein the one or more identifies comprises a mailer identifier, a recipient identifier, and a piece identifier.

16. The system of claim 12, wherein the indication is received at a third party service provider.

17. The system of claim 12, wherein the indication is received at the mailer.

18. The system of claim 15, wherein the computer system is to further receive a second indication via the cell phone from a postal recipient that an unsolicited mail piece is not desired, the second indication comprising the same mailer identifier as the first indication, and wherein the computer system is to further provide the data associated with the postal recipient to one or more mailers to indicate that the postal recipient requests to receive only a single mailing of the mail piece associated with the mailer identifier.
